(19) United States
(12) Patent Application Publication
(10) Pub. No.: US 2026/0288052 A1
(43) Pub. Date: Sep. 24, 2026

(54) IMAGE FORMING APPARATUS

(71) Applicant: CANON KABUSHIKI KAISHA, Tokyo (JP)

(72) Inventors: KUNIAKI TAMAGAKI, Kanagawa (JP); SHINGO ITO, Tokyo (JP); YUKO HARADA, Kanagawa (JP); NAOKI HAYASHI, Kanagawa (JP)

(21) Appl. No.: 19/541,621

(22) Filed: Feb. 17, 2026

(30) Foreign Application Priority Data
Mar. 19, 2025 (JP) 2025-046094

(51) Int. Cl. G03G 21/00

(52) U.S. Cl. CPC G03G 21/0035; G03G 2215/0132

(57) ABSTRACT

An image forming apparatus includes an image bearing member, a transfer member, a feeding portion and a cleaning member. The transfer member forms a transfer portion for transferring the toner image from the image bearing member to a recording material. The cleaning member has water absorbing property and provided so as to contact a surface, of the recording material fed out from the feeding portion and toward the transfer portion, which is in contact with the image bearing member in the transfer portion. The cleaning member has a water absorption time of less than 60 sec in measurement method for measuring a water absorption speed by a dropping method according to JIS L 1907:2010 and a water absorption height of 2 mm or more in measurement method for measuring a water absorption speed by Byreck Method according to JIS L 1907:2010.

### BACKGROUND

### Field of Technology

The present invention relates to an image forming apparatus such as a printer, a copying machine, and a facsimile device with an electrophotographic type.

### Description of the Related Art

The image forming apparatus such as a printer with electrophotographic type forms an image by an image forming process as follows. By that a surface of a photosensitive drum as a charged image bearing member is exposed, an electrostatic latent image is formed on the surface of the photosensitive drum. Also, by supplying a toner to this electrostatic latent image, a toner image is formed on the surface of the photosensitive drum. This toner image is transferred onto a recording material such as a sheet of paper, and then this toner image is fixed on the recording material and output as a printed product.

Occasionally, foreign matter contamination happens in the image forming apparatus, by which the image forming process is disturbed. In Japanese Laid-Open Patent Application No. H11-222333, a structure provided with a cleaning member that removes paper dust on the sheet of paper in order to suppress disturbing image forming process by paper dust generated from a sheet of paper as a recording material is disclosed. The structure disclosed in Japanese Laid-Open Patent Application No. H11-222333, the cleaning member is constituted with a metallic roller.

However, a foreign matter that disturbs image forming process is not only paper dust. Depending on a user's environment, it is possible that a variety of the foreign matters such as food, stationery, or cosmetics are adhered, for example, on the recording material set on a sheet feeding portion and enter inside of the image forming apparatus along with conveying the recording material.

### SUMMARY

Thereat, an objective of the present invention is to suppress to occur any malfunction caused by foreign matters adhering to the recording material and entering inside the image forming apparatus.

The objective above is achieved by the image forming apparatus in the present invention. In summary, according to one aspect of the present invention, an image forming apparatus comprising: an image bearing member configured to bear a toner image; a transfer member configured to form a transfer portion for transferring the toner image from the image bearing member to a recording material; a feeding portion on which the recording material is set; and a cleaning member having water absorbing property and provided so as to contact a surface, of the recording material fed out from the feeding portion and toward the transfer portion, which is in contact with the image bearing member in the transfer portion, wherein the cleaning member has a water absorption time of less than 60 sec in measurement method for measuring a water absorption speed by a dropping method according to JIS L 1907:2010 and a water absorption height of 2 mm or more in measurement method for measuring a water absorption speed by Byreck Method according to JIS L 1907:2010.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus.

FIG. 2 is a schematic cross-sectional view of a cleaning member.

FIG. 3, part(a), part(b), and part(c), is a schematic view of the cleaning member to explain its action.

FIG. 4, part(a), part(b), and part(c), is a schematic view to explain a criterion of cleaning performance.

FIG. 5 is a schematic cross-sectional view of an image forming apparatus in another embodiment.

### DESCRIPTION OF THE EMBODIMENTS

The image forming apparatus in the present invention will be explained in detail below with the drawings.

### <Whole Structure of an Image Forming Apparatus>

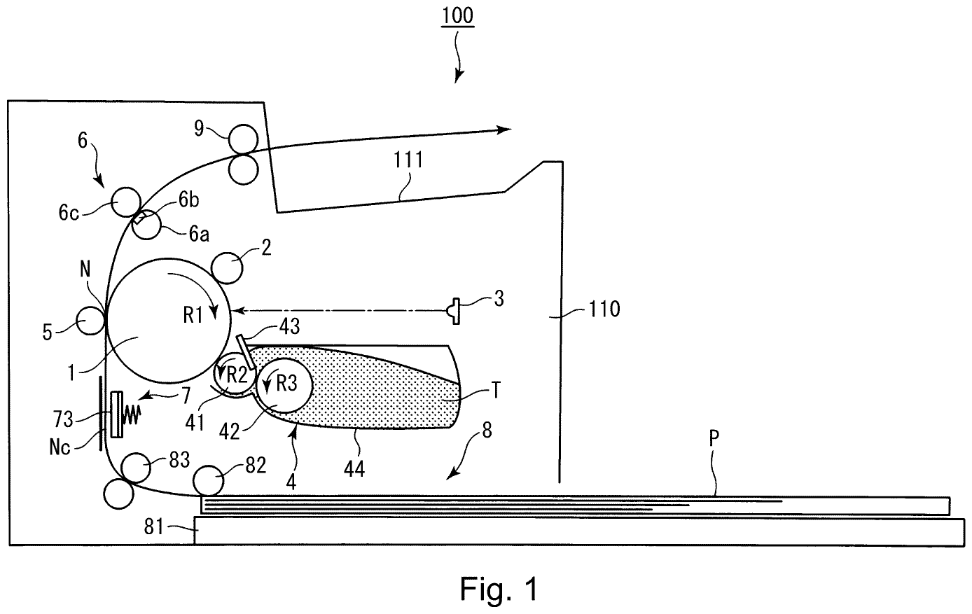

FIG. 1 is a schematical sectional view of an image forming apparatus 100 in a present embodiment. In the present embodiment, the image forming apparatus 100 is a monochrome printer that is able to form a black monochrome image on a recording material P which is a sheet shaped with an electro-photographic type (an electro photographic recording type).

The image forming apparatus 100 is comprised of: a photosensitive drum 1, a charging roller 2, an exposing device 3, a developing device 4, a transfer roller 5, and a fixing device 6. Also, the image forming apparatus 100 is comprised of a feeding device 8 and a discharging device 9. Furthermore, the image forming apparatus 100 is comprised of a cleaning device 7 to clean the recording material P.

The photosensitive drum 1 is an example of an image bearing member configured to bear a toner image. The photosensitive drum 1 comprises a rotatable drum shaped (cylinder shaped) photosensitive member (an electrophotographic sensitive member). In the present embodiment, the photosensitive drum 1 is structured with an organic photosensitive member with negative charged which is formed on an electroconductive cylinder connected to ground potential. Also, in the present embodiment, an outside diameter of the photosensitive drum 1 is 24 mm. The photosensitive drum 1 rotationally driven by a motor (not showing) as a driving source comprised a driving member in a direction of arrow R1 (a clockwise direction) in figures at a predetermined peripheral speed (a process speed). In the present embodiment, the peripheral speed of the photosensitive drum 1 is 139 mm/sec.

The charging roller 2 is an example of a charging means configured to charge on the surface of the photosensitive drum 1. In the present embodiment, the charging roller 2 which is a charging member with a roller type is structured with a conductive resin layers formed in a cylinder shape around a metallic core made of metal. The charging roller 2 is connected to a charging power source (a high voltage power source) as a charging voltage applying member (not showing in figures). The charging roller 2 is pressed onto the photosensitive drum 1 with a predetermined pressure and contacts the surface of the photosensitive drum 1. The charging roller 2 is driven and rotates with rotation of the photosensitive drum 1. The charging roller 2 uniformly charges on the surface of the photosensitive drum 1 that is rotating at a predetermined potential with a predetermined polarity (a negative polarity in the present embodiment). During charging procedure, the charging roller 2 is applied with a charging voltage (a charging bias) with a negative polarity by the charging power source.

The exposing device 3 is an example of an exposing member configured to form an electrostatic latent image (an electrostatic image) on the surface of the photosensitive drum 1 by exposing the surface of the photosensitive drum 1 that is charged. The exposing device 3 exposes the surface of the photosensitive drum 1 charged by the charging roller 2 corresponding to image information input in the image forming apparatus 100 from a host computer such as a personal computer or an outer device such as an image reading device. In the photosensitive drum 1, an electron-hole pair is separated by electrostatic force generated between the electroconductive cylinder connected to ground potential and the surface of the organic photosensitive member negatively charged; and a surface potential of the organic photosensitive member is decreased. Thus, the electrostatic latent image corresponding to the image information is formed on the surface of the photosensitive drum 1 with or without exposing. For the exposing device 3, a laser scanner unit configured to detect with a semiconductor laser on the surface of the photosensitive drum 1 or an LED exposing device including an LED alley aligned with several LED along a longitudinal side of the photosensitive drum 1 can be used. The laser scanner unit is used as the exposing device in the present embodiment.

The developing device 4 is an example of a developing means configured to develop (visualize) the electrostatic latent image formed on the surface of the photosensitive drum 1 with toner as a developer. The developing device 4 includes a developing roller 41 as a developer bearing member (a developing member) configured to bear the developer and a supplying roller 42 as a supplying member configured to supply the developer to the developing roller 41. Also, the developing device 4 includes a developing blade 43 as a restricting member configured to restrict amount of the developer born by the developing roller 41 and a developing container 44 configured to accommodate a toner T as the developer. The developing roller 41 and the supplying roller 42 are supported by the developing container 44 rotatably. The developing roller 41 and the supplying roller 42 are rotationally driven at a predetermined peripheral speed by transmitting a driving force of a motor (not shown) as a power source comprised a driving means in each an arrow R2 and an arrow R3 direction (counterclockwise direction) in figures.

The developing device 4 adopts a contact developing system as a developing system in the present embodiment. In other words, a toner layer born by the developing roller 41 contacts to the photosensitive drum 1 in a developing area (a developing portion). Further in other words, the developing roller 41 contacts to the photosensitive drum 1 through the toner layer and forms the developing area (the developing portion). The developing roller 41 is connected to a developing power source (a high voltage power source) as a developing voltage applying portion that is not shown in figures. During developing process, a developing voltage (a developing bias) with negative polarity is applied to the developing roller 41 by the developing power source. The toner T born by the developing roller 41 is moved from the developing roller 41 to the surface of the photosensitive drum 1 by potential difference between the potential of the surface of the photosensitive drum 1 and the developing voltage (potential of the developing roller 41). Therefore, the toner T is adhered to the electrostatic latent image on the surface of the photosensitive drum 1 and a toner image (a developer image) is formed. In the present embodiment, the toner charged with a same polarity as a charging polarity (a negative polarity in the present embodiment) of the photosensitive drum 1 is adhered on an exposing portion on the surface of the photosensitive drum 1 where an absolute value of potential is decreased by being exposed after being unitedly charged once (a reversal development method).

A normal charging polarity of the toner which is main charging polarity of the toner during developing process is a negative polarity in the present embodiment. Also, a round shaped polymerized toner generated by polymerization and its mean particle diameter is 6 μm is used as the toner T in the present embodiment. Further, the toner T is commonly known as a non-magnetic single component developer. In other words, the toner T does not include magnetic component, but is born by the developing roller 41 with intermolecular force or electrostatic force mainly. The single component developer sometimes includes additives (such as wax or silica fine particles) other than a toner particle to adjust fixity or charging performance of the toner T. Note that, a magnetic single component developer including magnetic component or a two-component developer including the toner T which is a non-magnetic and a magnetic carrier may be used as a developer. A cylinder-shaped developing sleeve in which a magnet is provided inside, for example, is used as the developer bearing member when a magnetic developer is used.

The recording material (transfer material, sheet) P in sheet shape such as paper is fed by the feeding device 8 to the transfer portion N described below. Note that, the recording material P is not limited to comprising of paper, but it may comprise of, material except paper such as plastic sheet and synthetic paper, or material including material other than paper. The feeding device 8 includes a feeding tray 81 as a feeding portion where the recording material P is set up, a picking roller 82 as a picking member, and a conveying roller 83 as a conveying member. Note that, the definition of setting up the recording material P widely includes relating the recording material P to the feeding portion to be able to send out the recording material P: to place it on the feeding portion, to lean it on the feeding portion, or to accommodate in the feeding portion, in detail. In the present embodiment, the recording material P is placed on the feeding tray 81. Only one piece on a top of the multiple recording material P stacked and placed on the feeding tray 81 is picked up and send out by the picking roller 82. This material P is conveyed by the conveying roller 83 to the transfer portion N at a predetermined timing corresponding to the toner image on the photosensitive drum 1.

The transfer roller 5 is an example of a transfer means configured to transfer the toner image born on the photosensitive drum 1 onto the recording material P. The transfer roller 5 which is a roller shaped transfer member is pressed toward the photosensitive drum 1 with a predetermined pressure and contacted to the surface of the photosensitive drum to form the transfer portion (a transfer nip) N which is a contact portion between the photosensitive drum 1 and the transfer roller 5. In the transfer portion N, the toner image formed on the photosensitive drum 1 is transferred ay an action of the transfer roller 5 onto the recording material P nipped and conveyed by the photosensitive drum 1 and transfer roller 5. The transfer roller 5 is connected to a transfer power source (a high voltage power source) as a transfer charge applying portion not shown in figures. In the transfer process, transfer charge (transfer bias) is applied to the transfer roller 5 by a transfer power source with an opposite polarity (a positive polarity in the present embodiment) of a normal charging polarity of the toner. The toner T born by the photosensitive drum 1 is transferred from the surface of the photosensitive drum 1 onto the recording material P by electric potential difference between the surface potential of the photosensitive drum 1 and a transfer potential (a potential of the transfer roller 5).

The fixing device 6 is an example of a fixing means configured to fix the toner image on the recording material P. In the present embodiment, the fixing device 6 is an example of a fixing means with a heat fixing method which is fixing procedure to the toner image on the recording material P by heating to melt the toner T on the recording material P. The fixing device 6 includes a fixing film 6a as a heating rotation member, a fixing heater 6b such as a ceramic heater as a heat source configured to heat the fixing film 6a, and a pressure roller 6c as a pressing rotation member configured to press the fixing film 6a. Also, inside (hollow part) of the fixing film 6a which is a cylinder shape, a thermistor configured to measure a temperature of the fixing heater 6b is provided. The fixing device 6 fixes the toner image on the recording material P by heating and pressing the recording material P bearing the unfixed toner image with the fixing film 6a and the pressing roller 6c.

After passing through the fixing device 6, the recording material P is discharged (output) from the image forming apparatus 100 towards the outside (of the apparatus) by a discharging roller comprised of the discharging device 9; and then stacked on a discharging tray 111 as a discharging portion formed on a top of an apparatus main body 110 of the image forming apparatus 100.

Further, the toner remained (transfer residual toner) on the surface of the photosensitive drum 1 without transferred onto the recording material P in the transfer portion N is collected by the developing device 4 (a simultaneous developing and cleaning system in the present embodiment. Note that, a cleaning device to remove the transfer residual toner may be provided in the image forming apparatus 100.

Here, the photosensitive drum 1 and a process means such as the charging roller 2 or the developing device 4 acting on the photosensitive drum 1 can be integrated as a process cartridge which can be attached to/detached from the main body 110 of the image forming apparatus 100.

In the present embodiment, the cleaning device 7 to clean the recording material P along the conveying path of the recording material P between the picking roller 82 and the transfer portion N in the image forming apparatus 100. The cleaning device 7 removes at least a part of a foreign matter (especially liquidity matter) while conveying the recording material P. The cleaning device 7 will be described in detail below.

### <Cleaning Device>

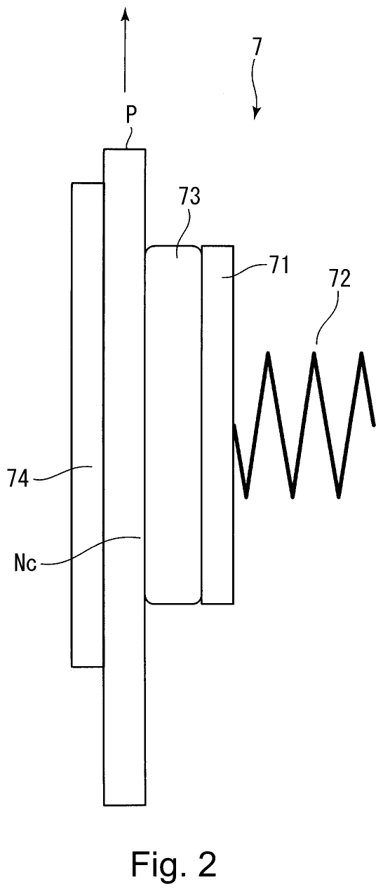

Next, the cleaning device 7 in the present embodiment will be described. FIG. 2 is a schematic sectional view around the cleaning device 7 in the present embodiment.

The cleaning device 7 includes a holding member 71 formed with a sheet metal, a pressing spring 72 comprised of a compressed coil spring which is an urging member as an urging means, and a water absorbing member 73 as a cleaning member with absorbency. The water absorbing member 73 is adhered and fastened on the holding member 71. A surface of the holding member 71 on which the water absorbing member 73 is attached is a flat surface in the present embodiment. Note that, as a fastening means to fasten the water absorbing member 73 on the holding member 71, any fastening means such as gluing, welding, adhering with a double sided tape, and a latching by a latching portion can be used.

Also, a opposing member 74 configured to oppose the water absorbing member 73 across the conveying path of the recording material P is provided in the image forming apparatus 100. The cleaning device 7 can be constituted as including the opposing member 74. The water absorbing member 73 forms a cleaning portion Nc by abutting the opposing member 74. Though a state is shown that the recording material P is cramped by the water absorbing member 73 and the opposing member 74 in FIG. 2, the water absorbing member 73 abuts the opposing member 74 when the recording material P is not present. One end of the pressing spring 72 is fastened to a bearing surface (not shown in figures) provided on an inside wall of the image forming apparatus 100 and the other end is fastened to the holding member 71. Therefore, the holding member 71 is pressed in a direction that the water absorbing member 73 moves toward the opposing member 74. Note that, the image forming apparatus 100 may include a restriction means configured to restrict an area the cleaning device 7 can move. For example, a rail or a rail like configured to restrict a movable area of the cleaning device as the restriction means can be used. Further, though the cleaning device 7 (the water absorbing member 73) is constituted as being able to move in straight direction in the present embodiment, the present invention is not limited to this constitution but the cleaning device 7 (the water absorbing member 73) can be constituted as being able to rotate. For example, it is possible that the holding member 71 is pressed in a direction that the water absorbing member 73 moving toward the opposing member 74 by a moment generated by the pressing spring 72 with a rotational axis provided in the holding member 71. It is also possible that the holding member 71 is pressed in a direction that the water absorbing member 73 moving toward the opposing member 74 with a weight of the cleaning device 7 itself (with effect of gravity) as setting the cleaning device 7 above the conveying path of the recording material P without the pressing spring 72. The cleaning device 7 is required to be constituted at least as the water absorbing member 73 being able to contact the recording material P in a proper posture to clean the recording material P.

The water absorbing member 73 can remove at least a part of a liquid foreign matter on the recording material P passing through the cleaning portion Nc. Especially, the water absorbing member 73 can remove at least a part of a liquid foreign matter on the specific surface of the recording material P by contacting to this surface of the recording material P which contacts to the photosensitive drum 1 in the transfer portion N right after passing through the cleaning portion Nc in the present embodiment. In the present embodiment, the size of the water absorbing member 73 is: a width in the conveying direction of the recording material P is 10 mm, a length in a direction roughly crossing perpendicular to the conveying direction of the recording material P is 220 mm which is longer than a shorter side of LTR size, and a thickness is 5 mm. Materials such as a brush comprised of relatively thin fiber, fabric, non-woven fabric, or a sponge with relatively small holes can be used as the water absorbing member 73. These materials are easy to hold liquidity by surface tension and have excellent water absorbent property because they have more interface between materials and air on a contact surface.

It is preferable that the width in the longitudinal direction of the water absorbing member 73 is longer enough than the length of the recording material P of which the width (a widest width) in a width direction crossing roughly perpendicular to the conveying direction is the longest among some kinds of the recording material P which are able to be conveyed from the feeding tray 81 to the transfer portion N. In other words, the water absorbing member 73 is preferably constituted as the longitudinal length of the water absorbing member 73 is longer enough to accommodate the widest width of the recording material P. The width of the water absorbing member 73 in the conveying direction of the recording material P can be accordingly set as relating to space inside the image forming apparatus 100 in order to perform the absorbent property adequately. When the water absorbing member 73 including a property described below is used, the width of the water absorbing member 73 in the conveying direction of the recording material P is; for example, appropriately about 5 mm through 30 mm, preferably about 5 mm through 20 mm, and more preferably about 5 mm through 15 mm. Note that, in terms of a numeral value range, the value of the numbers before and after included in the value range. Also, the thickness of the recording material P (a length of the fiber of the brush in a case that the water absorbing member 73 is a bruch shaped member) can be accordingly set as relating to endurance in order to perform the absorbent property adequately. When the water absorbing member 73 including a property described below is used, the thickness of the water absorbing member 73 is; for example, appropriately about 3 mm through 20 mm, preferably about 3 mm through 10 mm, and more preferably about 3 mm through 8 mm.

Note that, though the water absorbing member 73 includes a flat shape attached on a flat surface in the present embodiment, the present invention is not limited to this constitution. For example, the water absorbing member 73 may include a roller shape attached on a circumference of a rotatable member (a core metal) with a cylinder shape.

As described above, the recording material P stacked and placed on the feeding tray 81 is separated in each piece and conveyed to the transfer portion N. And then, the toner image on the photosensitive drum 1 is transferred onto the recording material P in the transfer portion N. At this time, a foreign matter such as food, stationery, or cosmetics are sometimes adhered to the recording material P by user's operating environment. Especially, a liquid foreign matter; has sometimes happened to splatter and be spilled on the recording material P, or has been moved from a user's hand to the recording material P when the user restocks the recording material P. Thus, there is possibility that, for example, the liquid foreign matter adhered to the recording material P placed on the feeding tray 81 enters in the image forming apparatus 100 along with conveying the recording material P and reaches a image forming portion (specifically the transfer portion N in the present embodiment). The liquid foreign matter may cause to occur an image malfunction. An example of the image malfunction will be described below. Also, it is conceivable that the liquid foreign matter causes a failure of the image forming apparatus 100, for example, in a situation where the liquid foreign matter often enters in the image forming apparatus 100.

Here, the liquid foreign matter includes not only general liquid such as water, but high viscosity liquid or liquid that contains solid component such as gel or foam. Though it is not limited to, the liquid foreign matter means following; water, food (beverages such as juice, coffee, tea, alcoholic beverage, condiments such as soy sauce, sauce, dressing, or oil, other food such as soup, yogurt, jam, or honey), cosmetics such as skin lotion, moisture milk, perfume, nail polish, nail polish remover, tooth paste, hair spray, shaving foam, or gel type cosmetic products), medication such as liquid medication, eye drops, or sanitizer, detergent such as liquid detergent or softener, or stationery such as ink or glue.

In the present embodiment, the water absorbing member 73 as the cleaning member with absorbency removes at least a part of the liquid foreign matter from the surface of the recording material P before the liquid foreign matter reaches the image forming portion (specifically the transfer portion N in the present embodiment). The water absorbing member 73 is a part constituted with a absorbent material which touches the surface of the recording material P that contacts to the photosensitive drum 1 in the cleaning device 7. Thus, to occur malfunction caused by the liquid foreign matter adhering on the recording material P and entering inside of the image forming apparatus 100 is suppressed.

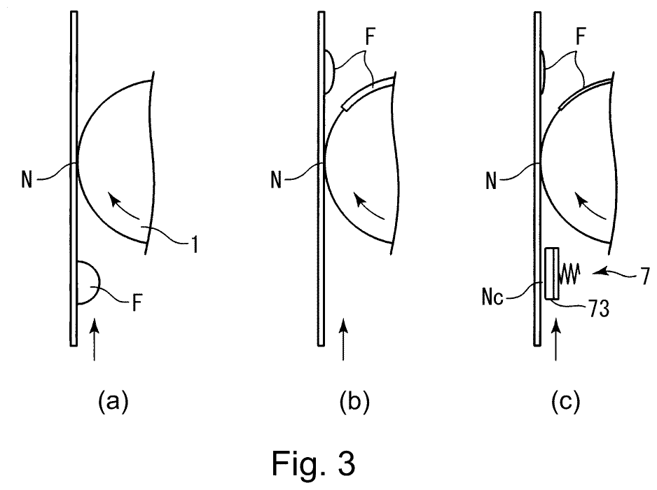

FIG. 3, part(a), part(b), and part(c), is a schematic view of a vicinity of the transfer portion N to describe an operation of the cleaning device 7. As FIG. 3(a) showing, a liquid foreign matter F is conveyed to the transfer portion N as being adhered on the recording material P. Without the cleaning device 7, the liquid foreign matter F is moved from the surface of the recording material P to the surface of the photosensitive drum 1 in the transfer portion N as FIG. 3(b) showing. On the other hand, in the case with the cleaning device 7, at least a part of the liquid foreign matter F is removed from the surface of the recording material P by the water absorbing member 73 of the cleaning device 7 before the liquid foreign matter F reaches the transfer portion N as FIG. 3(c) showing. Thus, the liquid foreign matter F moving from the surface of the recording material P to the surface of the photosensitive drum 1 is reduced. As a result, it becomes possible to suppress to occur malfunction such as image malfunction caused by the liquid foreign matter F even if the liquid foreign matter is adhered on the recording material P.

Further, for example, in a case the liquid foreign matter F is adhered on the recording material P loaded on the feeding tray 81, the liquid foreign matter F is mostly adhered on the top surface of the recording material P. Therefore, the water absorbing member 73 is preferred to be abutted on the top surface of the recording material P placed on the feeding tray 81. In other words, the water absorbing member 73 is preferred to be abutted on the surface of a side of recording material P where the picking roller 82 abuts to separate and convey each recording material P. In the present embodiment, the top surface of the recording material P placed on the feeding tray 81 contacts to the surface of the photosensitive drum 1 in the transfer portion N. In other words, the water absorbing member 73 contacts to the surface of the recording material P, where is the top surface of the recording material P placed on the feeding tray 81 and contacts to the photosensitive drum 1 in the transfer portion N after passing through the cleaning portion Nc, and removes at least the part of the liquid foreign matter from this surface of the recording material P in the present embodiment. With the constitution described above, the water absorbing member 73 can perform more effectively in the system which the top surface of the recording material P that the liquid foreign matter F more possibly adheres to contacts to the photosensitive drum 1.

### <Cleaning Performance of the Cleaning Device>

Next, an experiment showing cleaning performance of the cleaning device 7 conducted with examples and comparative examples will be described.

An image forming operation is performed through in the image forming apparatus 100 with the recording material P applied with the liquid foreign matter F. Then, the cleaning performance (cleaning ability) of the cleaning device 7 is compared by presence/absence and a size of a white dot generated upon an image. The experiments are specifically conducted as following. First, the liquid foreign matter F is applied in 3 mm diameter size on the recording material P and the image forming operation is performed through only for this one piece of the recording material P. Generally, a size of a liquid droplet spattered is about 3 through 5 mm diameter. It is assumed that the liquid foreign matter F is dripped or scattered around the recording material P or adhered through a user's body, clothes, or a stationery. After five minutes, the recording material P without any liquid foreign matter F adhered is output as an evaluation image to observe the extent of image malfunction, specifically about the presence or absence of the white spot and its size.

Here, an example of the image malfunction occurred by the liquid foreign matter F will be described. As described above, the liquid foreign matter F adhered on the recording material P is moved to the photosensitive drum 1 in the case without the cleaning device 7. As the photosensitive drum 1 rotates, the toner T is adhered on the liquid foreign material F from the developing roller 41. The toner T remains on the photosensitive drum 1 to shade exposing to form the electrostatic latent image in order to disturb forming the electrostatic latent image. Since the image forming apparatus 100 adopts the reversal development method which exposes an image portion in the present embodiment, the white spot in a half tone image or an omission of a letter in a text image are generated on the spot where the liquid foreign matter is adhered. Also, several white spots are occurred in equal interval of a length of a circumference of the photosensitive drum 1.

Therefore, it is possible to assess whether the cleaning device 7 has enough cleaning performance by checking whether the white spot described above is adequately suppressed to generate. In other words, it is possible to determine that cleaning device 7 has enough cleaning performance when the white spot described above is adequately suppressed to generate.

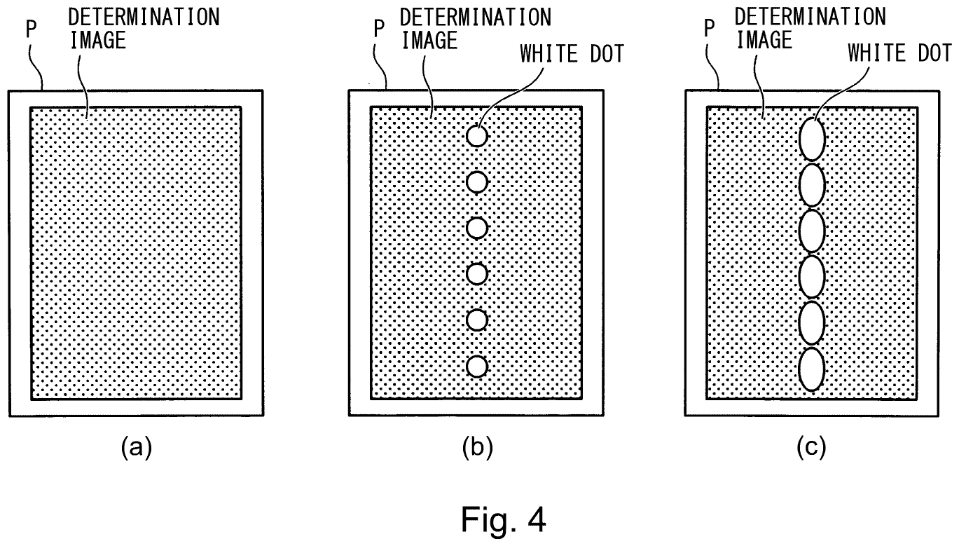

FIG. 4, part(a), part(b), and part(c), is a schematic view to explain a criterion about the white spot in the evaluation image. As the evaluation image, a half tone image with 25% pixel density as regarding a solid image as 100% is used. The evaluation criteria of the cleaning performance include 3 levels with symbols as following. “O” means no white spot is generated as shown in FIG. 4(a). “Δ” means that the white spot which is smaller than the size of the liquid foreign matter F when it is applied on the recording material P is generated as shown in FIG. 4(b). “X” means that the white spot which is larger than the size of the liquid foreign matter F when it is applied on the recording material P is generated as shown in FIG. 4(c). The reason why the white spot is generated larger than the size of the liquid foreign matter F when it is applied on the recording material P is assumed because the cleaning device 7 or the photosensitive drum 1 presses and extends the liquid foreign matter F. Though the cleaning performance is preferred to be “O” as an evaluation result described above, even “Δ” as an evaluation result described above is sometimes adequate for cleaning performance depends on the amount or features of the liquid foreign matter F.

In the present experiment “Skin Aqua super moisture gel C” made by ROHTO Pharmaceutical Co., Ltd. is used, as an example of the liquid foreign matter F. Also, “Red Label Presentation” made by CANON Europe Ltd. is used as an example of the recording material P in the present experiment.

In an Example 1, a brush material (brush shape member) including brush shape part which touches the recording material P is used as the water absorbing member 73. A bristle of the water absorbing member 73 includes flexibility. A brush fiber of which cross-sectional area is smaller than 350 μm² and of which density is more than 50 kF/inch² is used for the brush material. Following ingredients are used for a material of the brush fiber: polyester, nylon, polyurethane, mixture of two or more materials among these materials, and so on. Note that, the brush fiber material is not limited to them.

Table 1 shows results in Example 1; a water absorption speed measured by a dropping method according to JIS L 1907:2010 (here, simply called a water absorption speed by a dropping method), a water absorption speed measured by Byreck Method according to JIS L 1907:2010 (here, simply called a water absorption speed by Byreck Method), and cleaning performance. The water absorption speed by the dropping method is measured as described in the following, in accordance with JIS method mentioned above. Using a test piece that is 200 mm×200 mm with the brush's bristle length of 5 mm, a water drop is dropped from 10 mm above the surface of the 200 mm×200 mm side that the bristles are provided. A time until the specular reflection of the water drop on the test piece disappears is measured. Also, the water absorption speed by Byreck method is measured as described in the following, in accordance with JIS method mentioned above. Using a test piece that is 200 mm×25 mm with the brush's bristle length of 5 mm, 20 mm of the bottom edge of the 200 mm side of the test piece is soaked in a water tank. After 10 minutes, how much higher the water has moved up within the bristle of the test piece is measured.

TABLE 1

| | | | | | Water | | | | Cleaning |
|---|---|---|---|---|---|---|---|---|---|
| | Area of fiber | | Fiber | | dropping | | Byreck | | perfor- |
| | Cross-section | | density | | method | | method | | mance |
| Example 1-1 | 20 | μm² | 2310 | kF/inch² | 1 | sec | 25.6 | mm | ◯ |
| Example 1-2 | 20 | μm² | 1155 | kF/inch² | 1 | sec | 30.1 | mm | ◯ |
| Example 1-3 | 20 | μm² | 869 | kF/inch² | 1 | sec | 19.3 | mm | ◯ |
| Example 1-4 | 530 | μm² | 80 | kF/inch² | 8 | sec | 7.7 | mm | Δ |
| Example 1-5 | 20 | μm² | 80 | kF/inch² | 24 | sec | 101 | mm | ◯ |

In Example 2, a sponge shaped sponge material (sponge like member, elastic foam) with several air holes is used for the part which touches a recording material P, as the water absorbing member 73. As a sponge material, a material that has an average air hole diameter smaller than 25 μm and an air hole rate of more than 75% is used. As ingredients of the sponge material, a mixture of polyester and polyurethane is used. However, it is not limited to those two ingredients. Note that, the average air hole diameter is calculated by observing a surface of the sponge material with an optical microscope and measuring/counting each air hole diameter. Further, an Archimedes method that calculates the air hole rate by measuring/adding up an underwater weight, water saturation weight, and dry weight is used for measuring the air hole rate.

Table 2 shows results in the Example 2; a water absorption speed measured by a dropping method according to JIS L 1907:2010 (here, simply called a water absorption speed by a dropping method), a water absorption speed measured by Byreck Method according to JIS L 1907:2010 (here, simply called a water absorption speed by Byreck Method), and cleaning performance. Note that, if the air holes present on the sponge material are a mix of air holes with large air hole diameters and air holes with small air hole diameters, the average air hole diameter can be represented by the average air hole diameter of the small air holes. The water absorption speed by the dropping method is measured as described in the following, in accordance with JIS method mentioned above. Using a test piece that is 200 mm×200 mm×5 mm, a water drop is dropped from 10 mm above the surface of the 200 mm×200 mm side. A time until a specular reflection of the water drop on the test piece disappears is measured. Also, the water absorption speed by Byreck method is measured as described in the following, in accordance with JIS method mentioned above. Using a test piece that is 200 mm×25 mm×5 mm, 20 mm of the bottom edge of the 200 mm side of the test piece is soaked in a water tank. After 10 minutes, how much higher the water has moved up the sponge of the test piece is measured.

TABLE 2

| | Average | | | Water | | | Cleaning |
|---|---|---|---|---|---|---|---|
| | air hole | | Air hole | dropping | Byreck | | perfor- |
| | diameter | | rate | Method | Method | | mace |
| Example 2-1 | 25 | μm | 75% | 1 sec | 40.0 | mm | ◯ |
| Example 2-2 | 25 | μm | 90% | 1 sec | 40.0 | mm | ◯ |
| Example 2-3 | 300 | μm | 80% | 3 sec | 5 | mm | Δ |

In a comparative example 1, as substitute of the water absorbing member 73 in Examples 1 and 2, stainless steel, which is a material used for a conventional cleaning member configured to remove paper dust is used.

In a comparative example 2, as substitute of the water absorbing member 73 in Examples 1 and 2, polyoxymethylene (POM), a material used for a wall surface (a guiding portion) that defines the conveying path of the recording material P in the image forming apparatus 100 is used.

Table 3 shows results in the Examples 1 and 2; a water absorption speed measured by a dropping method and by Byreck Method according to JIS L 1907:2010, and cleaning performance.

TABLE 3

| | Water | | Cleaning |
|---|---|---|---|
| | dropping | Byreck | perfor- |
| | method | method | mance |
| Comparative | More than | Less than | X |
| example 1 | 60 sec | 1.0 mm | |
| Comparative | More than | Less than | X |
| example 2 | 60 sec | 1.0 mm | |

As Table 3 showing, both comparative examples 1 and 2 were not able to exhibit adequate cleaning performance against the liquid foreign matter while Examples 1 and 2 can exhibit excellent cleaning performance.

After inventors of the present invention reviewed the facts from both Tables 1 and 2, etc., it is obtained that the water absorbing member 73 comprising of the material that the water absorbing speed by water dropping method is less than 60 sec and the water absorbing speed by Byreck method is more than 2 mm can efficiently remove the liquid foreign matter F from the recording material P. Also, after the inventors of the present invention reviewed the facts from both Tables 1 and 2, etc., it is obtained that the water absorbing member 73 is preferable to comprise of the material that the water absorbing speed by water dropping method is less than 30 sec and the water absorbing speed by Byreck method is more than 5 mm. Furthermore, it is also obtained that the water absorbing member 73 is more preferable to comprise of the material the water absorbing speed by water dropping method is less than 10 sec and the water absorbing speed by Byreck method is more than 15 mm. Note that, the water absorbing speed by the water dropping method is not specifically restricted to its lowest value but 1 second is a measuring limit generally. However, a material that the water absorbing speed by water dropping method is actually less than 1 sec may be used as the water absorbing member 73. Also, the water absorbing speed by Byreck method is not specifically restricted to its highest value but 180 mm is a measuring limit generally. However, a material that the water absorbing speed by Byreck method is about 100 mm can be used as the water absorbing member 73. A material that the water absorbing speed by Byreck method is about 50 mm is mostly efficient and a material that the water absorbing speed by Byreck method is about 40 mm can be typically used.

Also, after inventors of the present invention reviewed the facts from Table 1, etc., it is obtained that; a cross sectional area of the brush fiber is preferred to be 530 μm² or less, and the brush fiber density is 50 kF/inch² or more, in order to exhibit excellent cleaning performance when the water absorbing member 73 including the brush shape like Example 1. Thus, the brush material comprising of the water absorbing member 73 is preferred to be thinner brush fiber and more number of the brush fiber. With this brush material, it is possible; to maximize the surface area per unit volume of the water absorbing member 73, and to raise surface tension between water (the liquid foreign matter F) and the brush material, so as to improve water absorbing performance. When the cross sectional area of the brush fiber is more than 530 μm², or the brush fiber density is less than 50 kF/inch², it is not possible to maximize the surface area per unit volume of the water absorbing member 73 adequately and the absorbing performance is not exhibited enough. Further, after inventors of the present invention reviewed the facts from Table 1, etc., it is obtained that; the cross sectional area of the brush fiber is preferable to be 530 μm² or less and the brush fiber density is preferable to be 80 kF/inch² or more, the cross sectional area of the brush fiber is more preferable to be 500 μm² or less and the brush fiber density is preferable to be 80 kF/inch² or more, and the cross sectional area of the brush fiber is furthermore preferable to be 20 μm² or less and the brush fiber density is preferable to be 80 kF/inch² or more. Note that, because there is a risk that the brush fiber is torn when the cross-section area of the brush fiber becomes 0.1p m² or less, the cross section area of the brush fiber is; supposed to be appropriately about 0.4 μm² or more, most likely adequate about 1 μm² or more, and typically about 10 μm² or more. Also, according to the facts from Table 1, etc., the brush density is most likely appropriate with about 5000 kF/inch² or less, though the more fiber density such as 800 kF/inch² or more, 1000 kF/inch² or more, and 2000 kF/inch² or more exhibits the better cleaning performance.

Also, after inventors of the present invention reviewed the facts from Table 2, etc., it is obtained that the average air hole diameter of the sponge material is preferred to be 300 μm or less and the air hole rate is preferred to be 75% or more in order to exhibit excellent cleaning performance when the water absorbing member 73 includes a sponge shape as Example 2. Thus, the sponge material comprising of the water absorbing member 73 is preferred that the air holes are small and the number of air holes are more. In the case that the diameters of the air holes are same and the air hole rate is larger, the number of the air holes becomes larger. With the sponge material in these conditions, it is possible; to maximize the surface area pre unit volume of the water absorbing member 73, and to raise the surface tension between the water (the liquid foreign matter F) and the brush material, so as to improve water absorbing performance. In the case that the average air hole diameter of the sponge material is more than 300 μm or the air hole rate is less than 75%, the surface area per unit volume of the water absorbing member 73 cannot be maximized efficiently and sometimes water absorbing performance becomes in adequate. Note that, according to the facts from Table 2, etc., the average air hole diameter is most likely appropriate with about 10 μm or more, though the smaller average air hole diameter such as 25 μm or less, 20 μm or less, and 15 μm or less exhibits the better cleaning performance. Further, according to the facts from Table 2, etc., the air hole rate of the sponge material is most likely appropriate with about 95% or less, though the higher air hole rate such as 80% or more, 90% or more exhibit better cleaning performance. In other words, the sponge material is; preferable with the average air hole diameter of 300 μm or less and the air hole rate 75% or more, and more preferable with the average air hole diameter of 25 μm or less and the air hole rate 90% or more.

Also, though the brush material and the sponge material are used as the water absorbing member 73 in the present embodiment, other material may be used if it includes enough water absorbing performance. For example, woven fabric or unwoven fabric, etc. may be used as the water absorbing member 73.

In a case that contact pressure which the water absorbing member 73 presses the recording material P is low, there is possibility the water absorbing member 73 separates from the recording material P by a vibration such as the vibration of the water absorbing member 73, When the water absorbing member 73 is contact to the recording material P with less than 5 gf/cm² pressure per unit area, the water absorbing member 73 sometimes separates from the recording material P in the constitution in the present embodiment. Therefore, the contact pressure of the water absorbing member 73 to the recording material P is preferred to be 5 gf/cm² or more pressure per unit area. The more pressure such as 10 gf/cm² or more, 20 gf/cm² or more, and 30 gf/cm² or more, the more excellent cleaning performance is exhibited. On the other hand, in a case that contact pressure which the water absorbing member 73 presses the recording material P is high, there is possibility that conveying the recording material P becomes harder. When the water absorbing member 73 is contact to the recording material P with more than 67 gf/cm² pressure per unit area, sometimes jamming (a paper jam) occurred by the water absorbing member 73 in the constitution in the present embodiment. Therefore, the contact pressure of the water absorbing member 73 to the recording material P is; preferable to be 67 gf/cm² or less contact pressure per unit area, most likely appropriate with about 50 gf/cm² or less, and typically about 40 gf/cm² or less. In other words, the water absorbing member 73 is preferred to be pressed to the recording material P with contact pressure per unit area between 5 gf/cm² and 67 gf/cm². Thus, the liquid foreign matter F can be removed and cleaned by the water absorbing member 73, a disturbance of conveying the recording material P can be suppressed by the water absorbing member 73. Note that, in a case that the water absorbing member 73 is urged by the pressing spring 72, the contact pressure per unit area mentioned above can be adjusted by the structure or alignment of the pressing spring 72. Also, in a case that the water absorbing member 73 is urged by its own weight (gravity action) as mentioned above, the contact pressure per unit area mentioned above can be adjusted by a weight of the supporting member 71 or the water absorbing member 73.

Note that, the image forming apparatus 100 is constituted with as the developing device 4 configured to collect the transfer residual toner on the photosensitive drum 1 in the present embodiment. With such constitution, it is assumed that adhering the liquid foreign matter F adhering to the photosensitive drum 1 from the recording material P remarkably affects, as compared with the constitution that the cleaning device configured to remove the transfer residual toner on the photosensitive drum 1 is provided. However, there is possibility that image malfunction is occurred by cleaning malfunction when the liquid foreign matter F is adhered on the photosensitive drum 1 from the recording material P even with the constitution that the cleaning device configured to remove the transfer residual toner on the photosensitive drum 1 is provided. Thus, the present invention can suppress to occur malfunction caused by the liquid foreign matter F entering inside of the image forming apparatus 100 through the recording material P by applying the constitution that the cleaning device configured to remove the transfer residual toner on the photosensitive drum 1 is provided.

In the present embodiment, the water absorbing member 73 (the cleaning portion Nc) is disposed in a downstream side of the conveying roller 83 and in an upstream side of the transfer portion N in a conveying direction of the recording material P from the feeding tray 81 to the transfer portion N. Meanwhile, the water absorbing member 73 (the cleaning portion Nc) may be disposed in a downstream side of the picking roller 82 and in an upstream side of the conveying roller 83 in a conveying direction of the recording material P from the feeding tray 81 to the transfer portion N. In other words, for example, the water absorbing member 73 can be disposed as a member that is contact first to the surface of the recording material P is contact to the photosensitive drum 1 in the transfer portion N after the recording material P is sent from the feeding tray 81. Thus, it is possible to suppress the liquid foreign matter F to move from the recording material P and adhere on the other members the recording material F touches while the recording material P from the feeding tray 81 to the transfer portion N.

As described above, according to the present embodiment, when the liquid foreign matter F such as a food, stationery, or cosmetics enters inside of the image forming apparatus 100 through the recording material P, it is possible to suppress to generate a malfunction such as an image malfunction caused by the liquid foreign matter F.

Next, a secondary embodiment will be described. In an image forming apparatus in the secondary embodiment, same and corresponding elements including same functions or constitutions are marked as same reference numerals with the elements in the image forming apparatus in the primary embodiment and explanations are omitted.

In the primary embodiment, the image forming apparatus 100 is a image forming apparatus with monochromatic method which is able to form an image with a monochrome black toner. However, the present invention can be applied to an image forming apparatus with a multi-color method which is able to form an image with a multi-colored (for example, 4 colors of yellow, magenta, cyan, and black) toner as well.

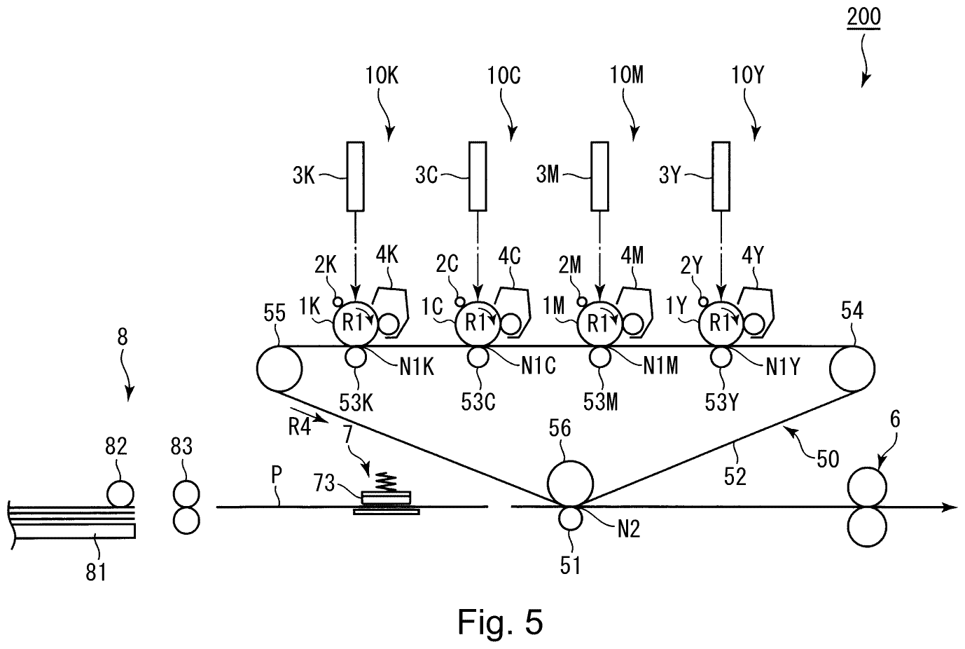

FIG. 5 is a schematic cross-sectional view showing a constitution of inside of an image forming apparatus 200 in the present embodiment. The image forming apparatus 200 in the present embodiment is a color printer with a tandem type adopting an intermediary transfer method which is able to form a full color image with a electrophotographic method.

The image forming apparatus 200 includes four image forming units; 10Y, 10M, 10C, and 10K, each unit forms a toner image with each color: yellow (Y), magenta (M), cyan (C), and black (K). Elements including same or corresponding function provided for each color will be sometimes described comprehensively as omitting Y, M, C, and K following reference numerals that shows which color the element provided for.

The image form unit 10 includes; a photosensitive drum 1 as a primary image bearing member configured to bear a toner image, a charging roller 2, an exposing device 3, and a developing device 4. These: photosensitive drum 1, the charging roller 2, the exposing device 3, and the developing device 4, includes same functions with the primary embodiment.

Also, the image forming apparatus 200 includes an intermediary transfer unit 50 provided as opposing four image forming units 10Y, 10M, 10C, and 10K. The intermediary transfer unit 50 includes an intermediary transfer belt 52 which is an intermediary transfer member comprising of an endless belt as a secondary image bearing member configured to bear a toner image. The intermediary transfer belt 52 is stretched by multiple stretch rollers following three rollers; a driving roller 54, a tension roller 55, and a secondary transfer opposing roller 56. The intermediary transfer belt 52 rotates (circumference move) in a direction of an arrow R4 (counter-clockwise) in FIG. 5 corresponding to the driving roller 54 rotating and transmitting a driving force. In an inner circumferential side of the intermediary transfer belt 52, primary transfer rollers 53Y, 53M, 53C, and 53K which are primary transfer members with roller shape as a primary transfer means corresponding to each photosensitive drum 1Y, 1M, 1C, and 1K are disposed. The primary transfer roller 53 is pressed onto the photosensitive drum 1, abutted through the intermediary transfer belt 52, and forms a transfer portion (a primary transfer nip) N1 (N1Y, N1M, N1C, and N1K) that is an abutting portion between the photosensitive drum 1 and the intermediary transfer belt 52. Note that, the photosensitive drum 1 rotates in a direction arrow R1 (clockwise) in FIG. 5. Also, the other stretch rollers and the primary transfer roller 53 than the driving roller 54 are rotated by rotation of the intermediary transfer belt 52.

A toner image formed on the photosensitive drum 1 is transferred (primary transfer) onto the rotating intermediary transfer belt 52 in the primary transfer portion N1 by an action of the primary transfer roller 53. In the primary transfer process, primary transfer charge (primary transfer bias) is applied to the primary transfer roller 53 with an opposite polarity of a normal charging polarity of the toner. For example, when the full-color image is formed, the toner images with each color of yellow, magenta, cyan, and black formed on the photosensitive drum 1 are sequentially transferred onto the intermediary transfer belt 52 as overlapping.

A secondary transfer roller 51 which is a secondary transfer member with a roller shape as a secondary transfer means is disposed in a position where is opposed to a secondary transfer opposing roller 56 through the intermediary transfer belt 52 in the outer circumferential side of the intermediary transfer belt 52. The secondary transfer roller 51; is pressed to the secondary transfer opposing roller 56, is abutted on the secondary transfer opposing roller 56 through the intermediary transfer belt 52, and forms a secondary transfer portion (a secondary transfer nip) where is a contact portion of the intermediary transfer belt 52 and the secondary transfer roller 51. In a secondary transfer portion N2, the toner image formed on the intermediary transfer belt 52 is transferred by an action of the secondary transfer roller 51 onto a recording material P nipped and conveyed by the intermediary transfer belt 52 and the secondary transfer roller 51. In the secondary transfer process, secondary transfer charge (secondary transfer bias) is applied to the secondary transfer roller 51 with an opposite polarity of a normal charging polarity of the toner. The secondary transfer opposing roller 56 is electrically grounded (connected to ground potential). Note that, it may be possible that rollers (inside members) as transfer members corresponding to the secondary transfer opposing roller 56 in the present embodiment is applied with the secondary transfer charge with the same polarity of the normal charging polarity of the toner, and outside members such as rollers corresponding to the secondary transfer roller 51 in the present embodiment is electrically grounded. The recording material P that the toner image transferred is discharged from the image forming apparatus 200 to outside after receiving fixing process in a fixing device 6.

The sheet shape recoding material P such as paper is fed to the secondary transfer portion N2 by a feeding device 8. The feeding device 8 includes a feeding tray 81, a picking roller 82, and a conveying roller 83. The feeding tray 81, the picking roller 82, and the conveying roller 83 include as same functions as the embodiment 1. The recording material P is conveyed to the secondary transfer portion N2 at a predetermined timing corresponding to the toner image on the intermediary transfer belt 52.

In the present embodiment, a cleaning device 7 configured to clean the recording material P is provided along a conveying path of the recording material P between the picking roller 82 and the secondary transfer portion N2 in the image forming apparatus 200. The cleaning device 7 includes a water absorbing member 73 as a cleaning member including absorbance and same functions as the embodiment 1.

As described above, with the water absorbing member 73 as same as the embodiment 1, it is suppressed that liquid foreign matters are adhered on the intermediary transfer member as a image bearing member (a secondary image bearing member).

According to the present invention, it is possible to suppress to occur malfunction caused by a liquid foreign matter that enters inside the image forming apparatus as adhering the recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-046094, filed on Mar. 19, 2025, which is hereby incorporated by reference herein in its entirety.

What is claimed is:

1. An image forming apparatus comprising:
an image bearing member configured to bear a toner image;
a transfer member configured to form a transfer portion for transferring the toner image from the image bearing member to a recording material;
a feeding portion on which the recording material is set; and
a cleaning member having water absorbing property and provided so as to contact a surface, of the recording material fed out from the feeding portion and toward the transfer portion, which is in contact with the image bearing member in the transfer portion,
wherein the cleaning member has a water absorption time of less than 60 sec in measurement method for measuring a water absorption speed by a dropping method according to JIS L 1907:2010 and a water absorption height of 2 mm or more in measurement method for measuring a water absorption speed by Byreck Method according to JIS L 1907:2010.

2. An image forming apparatus according to claim 1, wherein the cleaning member has the water absorption speed of 30 sec or less by the dropping method according to JIS L 1907:2010 and the water absorption speed of 5 mm or more by the Byreck Method according to JIS L 1907:2010.

3. An image forming apparatus according to claim 1, wherein the cleaning member has the water absorption speed of 10 sec or less by the dropping method according to JIS L 1907:2010 and the water absorption speed of 15 mm or more by the Byreck Method according to JIS L 1907:2010.

4. An image forming apparatus according to claim 1, wherein the cleaning member is constituted by a brush-like member, a cross-sectional area of a brush fiber of the brush-like member is 530 μm² or less and a density of the brush fiber is 50 kF/inch² or more.

5. An image forming apparatus according to claim 1, wherein the cleaning member is constituted by a sponge-like member, an average pore size of the sponge-like member is 300 μm or less and a porosity is 75% or more.

6. An image forming apparatus according to claim 1, wherein the feeding portion is constituted so that a top surface of the recording material set on the feeding portion is to be in contacted with the image bearing member when the recording material passes through the transfer portion first after the recording material is fed out from the feeding portion.

7. An image forming apparatus according to claim 1, wherein the cleaning member press-contacts the recording material with a pressure per unit area of 5 gf/cm² or more and 67 gf/cm² or less.

8. An image forming apparatus according to claim 1, wherein a length of the cleaning member in a widthwise direction substantially perpendicular to a conveyance direction of the recording material fed out from the feeding portion and toward the transfer portion is longer than a length of the recording material capable of being conveyed from the feeding portion to the transfer portion.

9. An image forming apparatus according to claim 1, wherein the image bearing member is a photosensitive member.

10. An image forming apparatus according to claim 1, further comprising a developing device configured to supply toner to the image bearing member and to form the toner image on the image bearing member,
wherein the toner remaining on the image bearing member after the toner image is transferred from the image bearing member to the recording material is collected by the developing device.

11. An image forming apparatus according to claim 1, wherein the image bearing member is an intermediary transfer member configured to convey the toner image primarily transferred from another image bearing member to secondarily transfer to the recording material in the transfer portion.
